(19) United States
(12) Patent Application Publication
(10) Pub. No.: US 2016/0205539 A1
(43) Pub. Date: Jul. 14, 2016

(54) Configurable base station

(71) Applicant: Nokia Technologies Oy, Espoo (FI)

(72) Inventors: Yang Liu, Beijing (CN); Haitao li, Beijing (CN)

(21) Appl. No.: 14/902,009

(22) PCT Filed: Jul. 1, 2013
(86) PCT No.: PCT/CN2013/078583

§ 371 Date: Dec. 30, 2015

(51) Int. Cl. H04W 8/22

(52) U.S. Cl. CPC H04W 8/22

(57) ABSTRACT

In accordance with an example embodiment of the present invention, there is provided an apparatus, comprising at least one processing core configured to determine whether to switch a first base station from a first mode to a second mode, wherein when in the second mode the first base station is at least in part controlled by a second base station, and a transmitter configured to cause a message comprising an indication of the determination to be transmitted toward at least one of the first base station and the second base station.

### TECHNICAL FIELD

The present application relates generally to managing operation of nodes in cellular communication networks.

### BACKGROUND

Cellular communication systems are comprised of cells. Each cell in a cellular communication system may be controlled by a base station or access point device, wherein a base station may be arranged to control more than one cell, for example where cells are formed as directional sectors or where cells are configured to operate on different frequencies.

Cellular communication systems may operate in accordance with industry standards, such as for example wideband code division multiple access, WCDMA, long term evolution, LTE, global system for mobile communication, GSM, interim standard 95, IS-95, and wireless local area network, WLAN, standards. A mobile terminal operating in accordance with the same standard as the communication system may obtain access to the system to provide communication service to a user operating the mobile terminal.

When mobile terminals roam in a coverage area of a cellular communication system, they may move from a coverage area of a first cell to a coverage area of a second cell. To maintain connectivity toward the cellular communication system, the serving cell of such a terminal may be reassigned from the first cell to the second cell. The mobile terminal may periodically measure for signals transmitted from the first and second cells to find out, when a handover from the first cell to the second cell is useful. For example, when the mobile terminal detects that a signal strength of a signal transmitted from the first cell declines while a signal strength of a signal transmitted from the second cell increases, the terminal may conclude it is moving toward the second cell.

Heterogeneous networks comprise cells of varying sizes, which may be referred to as macrocells and small cells. Macrocells may be configured to provide wide-area coverage, while small cells with smaller cell coverage areas may be configured to provide increased communication capacity in areas with high network traffic, for example. A cell coverage area of a small cell may be enclosed inside a cell coverage area of a macrocell.

A core network directs functioning of a cellular communication system and controls base stations to perform according to policies defined by network operators. A core network may control base stations via direct connections between core network nodes and base stations, or indirectly via radio network controller nodes, the radio network controller nodes having direct connections to both core network nodes and base stations.

### SUMMARY

Various aspects of examples of the invention are set out in the claims.

According to a first aspect of the present invention, there is provided an apparatus, comprising at least one processing core configured to determine whether to switch a first base station from a first mode to a second mode, wherein when in the second mode the first base station is at least in part controlled by a second base station, and a transmitter configured to cause a message comprising an indication of the determination to be transmitted toward at least one of the first base station and the second base station.

According to a second aspect of the present invention, there is provided a method, comprising determining whether to switch a first base station from a first mode to a second mode, wherein when in the second mode the first base station is at least in part controlled by a second base station, and causing a message comprising an indication of the determination to be transmitted toward at least one of the first base station and the second base station

According to a third aspect of the present invention, there is provided an apparatus, comprising at least one processor, at least one memory including computer program code, the at least one memory and the computer program code being configured to, with the at least one processor, cause the apparatus to at least determine a load condition in a core network node, and responsive to the determination, cause a message to be transmitted to a base station node, the message comprising at least one of an indication of the load condition and an instruction to switch the base station node from a first mode to a second mode, wherein when in the second mode the base station node is at least in part controlled by a second base station.

According to a fourth aspect of the present invention, there is provided a method, comprising determining a load condition in a core network node, and responsive to the determination, causing a message to be transmitted to a base station node, the message comprising at least one of an indication of the load condition and an instruction to switch the base station node from a first mode to a second mode, wherein when in the second mode the base station node is at least in part controlled by a second base station node.

According to further aspects of the present invention, computer programs are provided that are configured to cause methods in accordance with the second and fourth aspects to be performed, when run.

### BRIEF DESCRIPTION OF THE DRAWINGS

For a more complete understanding of example embodiments of the present invention, reference is now made to the following descriptions taken in connection with the accompanying drawings in which:

FIG. 1A illustrates a first mode in an example system capable of supporting at least some embodiments of the invention.

FIG. 1B illustrates a second mode in an example system capable of supporting at least some embodiments of the invention;

FIG. 2 illustrates a block diagram of an apparatus in accordance with an example embodiment of the invention;

FIG. 3 is a signaling diagram showing operations in accordance with an example embodiment of the invention;

FIG. 4 is a first flow diagram illustrating a first method in accordance with an example embodiment of the invention, and

FIG. 5 is a second flow diagram illustrating a second method in accordance with an example embodiment of the invention.

### DETAILED DESCRIPTION OF THE DRAWINGS

Core network nodes have limited capacity to interact with base stations. In cases where a core network node, such as for example a mobility management entity, MME, is highly loaded it may be beneficial for base stations to re-arrange their hierarchical relationships so that not all base stations need be controlled by the core network node, and at least one base station may be at least in part controlled by another base station instead. Likewise, base stations may choose to adopt a mode of functioning where at least one base station may be at least in part controlled by another base station in response to serving mobiles capable of attaching to such an arrangement of base stations.

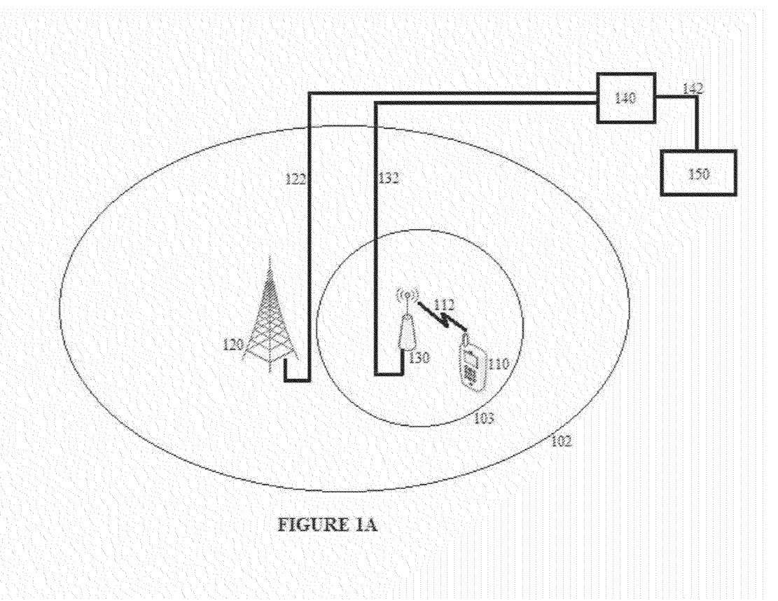

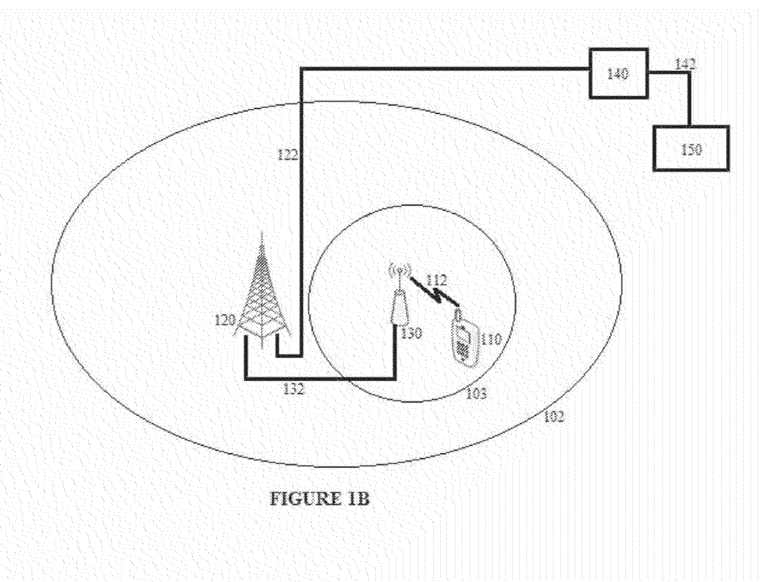

FIG. 1A illustrates a first mode in an example system capable of supporting at least some embodiments of the invention. Illustrated is mobile 110, which may comprise, for example, a user equipment, cellular telephone, laptop computer, tablet computer, personal digital assistant, PDA, wireless sensor or other mobile device with connectivity functions. Illustrated is also base station 120. Base station 120 may be configured to operate in accordance with a cellular communication standard, such as for example long term evolution, LIE, or wideband code division multiple access, WCDMA. Base station 120 controls cell 102, which is considered to be a macrocell.

Illustrated is also base station 130, which controls cell 103. Cell 103 may be considered a small cell, the coverage area of which is in this example enclosed within the coverage area of cell 102. However, the invention is not restricted hereto and in some embodiments the cell coverage area of cell 103 may be, in part or in whole, outside that of cell 102. Base station 130 is illustrated as being in wireless communication with mobile 110 via wireless link 112. Wireless link 112 may comprise an uplink for conveying information from mobile 110 to base station 130. Wireless link 112 may comprise a downlink for conveying information from base station 130 to mobile 110. When mobile 110 supports a wireless communication standard that base station 130 uses, wireless link 112 may be set up using this shared standard, to achieve interoperability between mobile 110 and base station 130. Base station 130 may operate in accordance with the same standard as base station 120, or in accordance with a different standard.

The term “base station” in connection with entity 130 is terminological only, and it is to be understood that in some embodiments other terms, such as for example “access point”, may be seen as more usual or appropriate. In some embodiments, cell 103 is not a small cell but a macrocell like cell 102. In some embodiments, cell 102 may be a small cell, and cell 103 a macrocell or a small cell.

First core network node 140 is in the example of FIG. 1A in communication with base station 120 and base station 130 via connections 122 and 132, respectively. First core network node 140 may use connection 122 to control, at least in part, base station 120. First core network node 140 may use connection 132 to control, at least in part, base station 130. Controlling at least in part a base station may comprise, for example, managing use of radio resources in at least one cell controlled by the base station. Controlling at least in part a base station may comprise indicating to the base station that due to a load constraint, radio access of more users should be limited, for example by rejecting new service requests from incoming mobiles. Managing use of radio resources may comprise, for example, authorizing use of channels and/or spreading codes for use in communication between a base station and a mobile. Managing use of radio resources may alternatively or in addition comprise, for example, setting maximum interference levels that radio communications in a cell may generate. Managing use of radio resources may be performed periodically, wherein a maximum interference level is updated once per minute, for example. Managing use of radio resources may be performed responsive to request, wherein for example a core network node may authorize use of resources responsive to a request from a base station for use of the resources. Use of resources may be authorized in whole or in part, for example where a base station requests permission to use ten spreading codes for communication, a core network node may authorize use of five spreading codes.

Second core network node 150 may communicate with first core network node 140 via connection 142, which may be, for example, a wire-line connection. Second core network node 150 may comprise, for example, a gateway configured to provide connectivity to further networks. Although illustrated as being controlled by the same core network node in FIG. 1A, base station 120 and base station 130 may in other embodiments be controlled by different core network nodes.

FIG. 1B illustrates a second mode in an example system capable of supporting at least some embodiments of the invention. The arrangement of FIG. 1B is similar to that of FIG. 1A except as it relates to connection 132. Unlike FIG. 1A, base station 130 is here controlled, at least in part, via connection 132 by base station 120. Base station 120 itself remains controlled by first core network node 140 via connection 122, as in FIG. 1A. In the arrangement of FIG. 1B, base station 120 performs at least some of the controlling functions described above, to at least in part control base station 130. An effect of this is that the core network needn't control base station 130 to the same extent as in the arrangement of FIG. 1A, resulting in a lower load in the core network. Another advantage of the arrangement of FIG. 1B is that when base station 120 is disposed close to base station 130, base station 120 may possess information on the radio environment of base station 130 that facilitates controlling base station 130. Such information may comprise, for example, channel-specific or location-specific interference levels. In this sense control by base station 120 may be more immediate and effective than control by a remotely sited core network node.

Connection 132 in FIG. 1A and FIG. 1B may be understood as a logical connection. Base station 130 may have a physical connection, such as for example a connecting wire, to both first core network node 140 and to base station 120. When base station 130 is in a first mode, it may use the physical connection to first core network node 140 for connection 132. When base station 130 is in a second mode, it may use the physical connection to base station 130 for connection 132. Alternatively, base station 130 may have a physical connection only to base station 130. In this case, the arrangement of FIG. 1A may still be possible in the sense that connection 132 between base station 130 and first core network node 140 is routed via base station 120, and first core network node 140 controls base station 130 by signaling to base station 130 via base station 120. In this sense the first and second modes may relate to the identity of the node controlling base station 130 rather than a physical arrangement of connecting wires.

In certain situations, it may be beneficial for base station 130 to switch from the first mode to the second mode, in other words for base station 130 to switch from being controlled by first core network node 140 to being at least in part controlled by base station 120. This may be the case, for example, where a core network node involved in controlling base station 130 becomes highly loaded. In this case, at least part of the controlling load is transferred from the core network node to base station 120, and the load situation in the core network node may be reduced. In effect, at least part of the signaling between base station 130 and first core network node 140 that is present on connection 132 in the first mode may be concealed from the core network in when base station 130 in the second mode, that is when it is controlled at least in part by base station 120.

Another example of a situation when it may be beneficial for base station 130 to switch from the first mode to the second mode is where base station 120 is highly loaded and it desires to offload at least part of its traffic. In case the cell coverage areas of cells 102 and 103 overlap, a mobile attached to base station 120 may be able to hand over to being attached to base station 130, thereby reducing a load of base station 120. Base stations 120 and 130 may agree on the switch of mode of base station 130 by exchanging signaling messages between each other. After the handing-over of at least one mobile from base station 120 to base station 130, and after the switch of base station 130 from the first mode to the second mode, base station 130 may continue to operate as a serving base station for the at least one handed-over mobile, but radio aspects of the connection to the at least one handed-over mobile will be handled by base station 130. In this regard, base station 120 may maintain at least partly control over the mobile but doesn't need to process radio aspects of the connection to the mobile, which reduces a processing load in base station 120.

Base station 130 may determine to initiate a process to transition from the first mode to the second mode at least in part responsive to receiving from a mobile an indication that the mobile supports a capability, such as for example dual connectivity or a radio access technology employed by base station 130. Dual connectivity may comprise that a mobile is connected with two base stations at a time, for example the mobile may receive downlink data from both base stations at the same time, over respective connections to the two base stations.

Base station 130 may determine to initiate a process to transition from the first mode to the second mode at least in part responsive to receiving from a core network node an indication the core network node is operating under a high load. Base station 130 may determine to initiate a process to transition from the first mode to the second mode at least in part responsive to receiving from base station 120 a request for base station 130 to switch to the second mode. When base station 120 requests the second mode from base station 130, base station 130 may select base station 120 as the base station at least in part controlling base station 130 when in the second mode. When a core network node indicates high load and base station 130 responsively initiates the process to transition from the first mode to the second mode, base station 130 may select a base station and inquire from the selected base station, if it is willing to accept base station 130 at least partly under its control in the second mode. Base station 130 may be configured, for example, to select a base station to which base station 130 has a physical interface as the base station to at least partly control base station 130 in the second mode.

In general there is provided a first apparatus, such as for example a base station or a control device configured to control a base station when implanted in the base station. Examples of control devices include a processor and a chipset. The first apparatus may comprise at least one processing core configured to determine whether to switch a first base station from a first mode to a second mode, wherein when in the second mode the first base station is at least in part controlled by a second base station. The first apparatus may comprise or be comprised in the first base station. The first apparatus may comprise or be comprised in a core network element, such as for example a mobility management entity, MME. The first apparatus may further comprise a transmitter configured to cause a message comprising an indication of the determination to be transmitted toward at least one of the first base station and the second base station. Where the first apparatus comprises a base station, the transmitter may comprise a signaling transmitter the base station employs to communicate with further nodes. Where the first apparatus comprises a control device, the transmitter may comprise an output port of the control device, the output port being configured to signal to a transmitter of a base station internally in the base station when the control device is implanted in the base station.

In some embodiments, the first base station being at least in part controlled by the second base station comprises at least one of the first base station allowing the second base station to perform a role of serving base station to at least one user equipment connected to the first base station and the first base station allowing the second base station to manage radio resources of the first base station. A role of serving base station may comprise terminating an upper connection, such as for example a S1-MME association, to a core network node, while appearing toward the core network node as if the user equipment is consuming radio resources of the serving base station.

In some embodiments, the determination whether to switch from the first mode to the second mode is based at least in part on an overload indication received in the first base station from a core network node. The indication may be received via connection 132, for example. In some embodiments, the determination is based at least in part on a capability indication received from a user equipment. In some embodiments, the determination is based at least in part on a result of a verification of core network node information based on a temporary mobile subscriber identity, TMSI, received from a user equipment. The verification may comprise determining, based on the temporary mobile subscriber identity, an identity of a core network node associated with the user equipment, and determining whether the identified core network node is operating under high load. If the identified core network node is operating under high load, base station 130 may be caused to enter the second mode with respect to the user equipment that sent the temporary mobile subscriber identity. The temporary mobile subscriber identity may be received in a connection request, for example. In some embodiments, the determination whether to switch from the first mode to the second mode is based at least in part on a load status in a base station that would at least in part control the first base station in the second mode.

In some embodiments, when the first base station is in the first mode, it is configured to broadcast a negative closed subscriber group cell indicator. A negative closed subscriber group cell indicator may be broadcasted in a system information block, for example, such as a system information block 1.

In some embodiments, the at least one processing core is configured to select, based on at least one criterion, one of a plurality of macro base stations to act as the second base station. The criterion may comprise, for example, a load status in the macro base station or a load status in a core network node associated with the macro base station.

In general there is provided a second apparatus, comprising at least one processor, at least one memory including computer program code, the at least one memory and the computer program code configured to, with the at least one processor, cause the apparatus to at least determine a load condition in a core network node, and responsive to the determination, cause a message to be transmitted to a base station node, the message comprising at least one of an indication of the load condition and an instruction to switch the base station node from a first mode to a second mode, wherein when in the second mode the base station node is at least in part controlled by a second base station node. The base station node may be a base station node the second apparatus is at least in part controlling, wherein a switch of the base station node to the second mode reduces an operating load of the second apparatus. The second apparatus may comprise, for example, a core network node such as for example a mobility management entity.

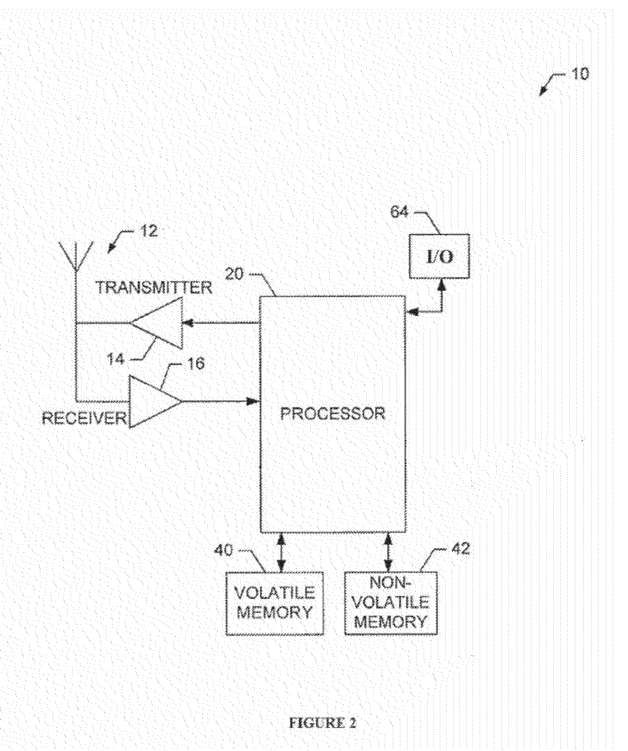

FIG. 2 illustrates a block diagram of an apparatus 10 such as, for example, a base station, in accordance with an example embodiment of the invention.

As shown, the apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example a memory. The processor 20 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit, ASIC, or field programmable gate array, FPGA, or some combination thereof. A processor comprising exactly one processing core may be referred to as a single-core processor, while a processor comprising more than one processing core may be referred to as a multi-core processor. Accordingly, although illustrated in FIG. 2 as a single processor, in some embodiments the processor 20 comprises a plurality of processors or processing cores. Signals sent and received by the processor 20 may include signaling information in accordance with an air interface standard of an applicable cellular system, and/or any number of different wireline or wireless networking techniques, comprising but not limited to Wi-Fi, wireless local access network, WLAN, techniques such as Institute of Electrical and Electronics Engineers, IEEE, 802.11, 802.16, and/or the like. In addition, these signals may include speech data, user generated data, user requested data, and/or the like. In this regard, the apparatus may be capable of operating with one or more air interface standards, communication protocols, modulation types, access types, and/or the like. More particularly, the apparatus may be capable of operating in accordance with various first generation, 1G, second generation, 2G, 2.5G, third-generation, 3G, communication protocols, fourth-generation, 4G, communication protocols, Internet Protocol Multimedia Subsystem, IMS, communication protocols, for example, session initiation protocol, SIP, and/or the like. For example, the apparatus may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the mobile terminal may be capable of operating in accordance with 2.5G wireless communication protocols General Packet Radio Service. GPRS, Enhanced Data GSM Environment, EDGE, and/or the like. Further, for example, the apparatus may be capable of operating in accordance with 3G wireless communication protocols such as Universal Mobile Telecommunications System, UMTS, Code Division Multiple Access 2000, CDMA2000, Wideband Code Division Multiple Access, WCDMA, Time Division-Synchronous Code Division Multiple Access, TD-SCDMA, and/or the like. The apparatus may be additionally capable of operating in accordance with 3.9G wireless communication protocols such as Long Term Evolution, LIE, or Evolved Universal Terrestrial Radio Access Network, E-UTRAN, and/or the like. Additionally, for example, the apparatus may be capable of operating in accordance with fourth-generation, 4G, wireless communication protocols such as LTE Advanced and/or the like as well as similar wireless communication protocols that may be developed in the future. The apparatus may comprise a wired interface I/O 64, which may be configured to enable the apparatus to communicate with other apparatuses, which may include base stations, radio access network controllers and core network entities, for example.

The apparatus 10 may include volatile memory 40 and/or non-volatile memory 42. For example, volatile memory 40 may include Random Access Memory, RAM, including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, etc., optical disc drives and/or media, non-volatile random access memory, NVRAM, and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions.

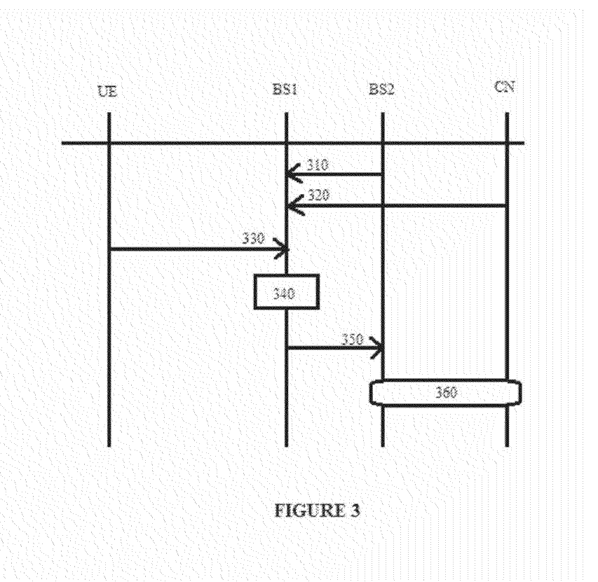

FIG. 3 is a flow diagram showing operations in accordance with an example embodiment of the invention. On the vertical axes are illustrated, from left to right, user equipment UE, first base station BS1, second base station BS2 and core network node CN. Time advances from top to bottom. In optional phase 310, second base station BS2 indicates to first base station BS1 at least one of that second base station BS2 is not in an overload situation, that a core network node associated with second base station BS2 is not in an overload situation, and that second base station BS2 supports a second mode where second base station BS2 at least in part controls another base station. In optional phase 320, core network node CN indicates to first base station BS1 that core network node CN is in an overload situation. Phase 320 may comprise a request for first base station BS1 to switch to the second mode and request control at least in part from another base station. In phase 330, user equipment UE may transmit an access request to first base station BS1. In phase 340, at least in part responsive to the message of phase 330, first base station BS1 may be configured to verify based on an identity of user equipment UE comprised in the request of phase 330, whether a core network node which is associated with both user equipment UE and base station BS2 is in an overload state. The core network entity may comprise a MME, for example.

Responsive to a determination in phase 340 that no overload condition in base station BS2 prevents switching to the second mode, first base station BS1 in phase 350 transmits a request to second base station BS2 for first base station BS1 to become at least in part controlled by second base station BS2. Switching to the second mode may be desirable particularly where it is determined in phase 340 that the core network node which is associated with user equipment UE and base station BS2 is in a high load state. In some embodiments, only the load status of core network node CN is determined. Finally in phase 360, first base station is in the second mode, and core network node CN sees second base station BS2 as a serving base station of user equipment UE, while user equipment UE is in radio communication with first base station BS1. In case the message of phase 330 does not comprise an identity of user equipment UE, such as for example a TMSI, the determination of phase 340 may be omitted and a non-overloaded core network node selected.

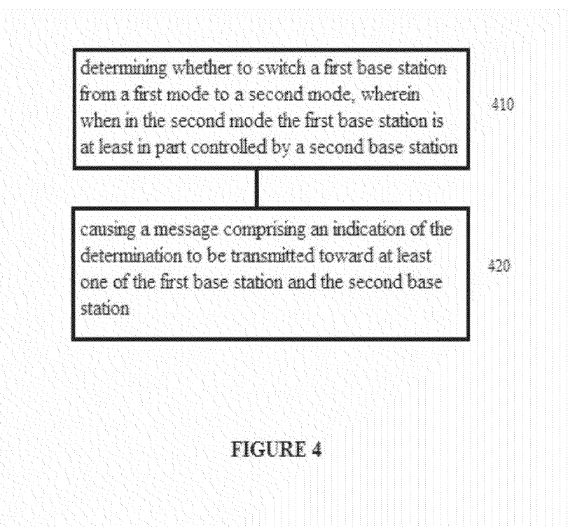

FIG. 4 is a first flow diagram illustrating a first method in accordance with an example embodiment of the invention. The phases of the illustrated method may be performed in base station 130 or a core network node, for example. Phase 410 comprises determining whether to switch a first base station from a first mode to a second mode, wherein when in the second mode the first base station is at least in part controlled by a second base station. Phase 420 comprises causing a message comprising an indication of the determination to be transmitted toward at least one of the first base station and the second base station

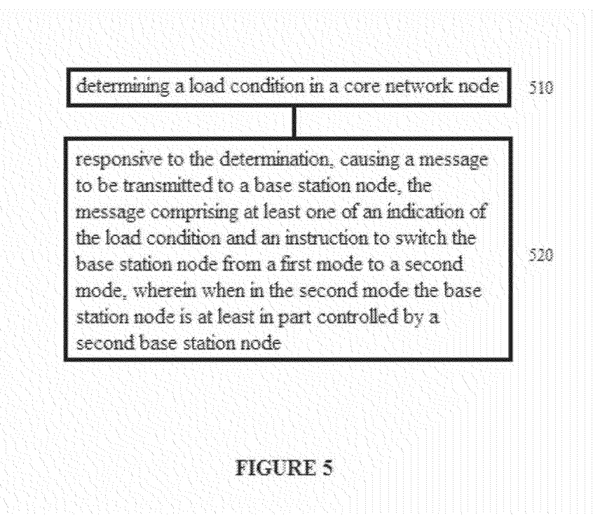

FIG. 5 is a second flow diagram illustrating a second method in accordance with an example embodiment of the invention. The phases of the illustrated method may be performed in a core network node, for example. Phase 510 comprises determining a load condition in a core network node. Phase 520 comprises, responsive to the determination of phase 510, causing a message to be transmitted to a base station node, the message comprising at least one of an indication of the load condition and an instruction to switch the base station node from a first mode to a second mode, wherein when in the second mode the base station node is at least in part controlled by a second base station node.

Without in any way limiting the scope, interpretation, or application of the claims appearing below, a technical effect of one or more of the example embodiments disclosed herein is that a load status of a core network node may be controlled. Another technical effect of one or more of the example embodiments disclosed herein is that a load status of a base station may be controlled.

Embodiments of the present invention may be implemented in software, hardware, application logic or a combination of software, hardware and application logic. The software, application logic and/or hardware may reside on memory 40, the control apparatus 20 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
at least one processing core configured to determine whether to switch a first base station from a first mode to a second mode, wherein when in the second mode the first base station is at least in part controlled by a second base station, and
a transmitter configured to cause a message comprising an indication of the determination to be transmitted toward at least one of the first base station and the second base station.

2. The apparatus according to claim 1, wherein the first base station being at least in part controlled by the second base station comprises at least one of the first base station allowing the second base station to perform a role of serving base station to user equipments connected to the first base station and the first base station allowing the second base station to manage radio resources of the first base station.

3. The apparatus according to claim 1, wherein the determination is based at least in part on an overload indication received in the first base station from a core network node.

4. The apparatus according to claim 1, wherein the determination is based at least in part on a capability indication received from a user equipment.

5. The apparatus according to claim 4, wherein the capability indication comprises an indication the user equipment supports dual connectivity.

6. The apparatus according to claim 1, wherein the determination is based at least in part on a result of a verification of core network node information based on a temporary mobile subscriber identity received from the user equipment.

7. The apparatus according to claim 1, wherein when the first base station is in the first mode, a S1 interface connects the first base station to a mobility management entity disposed in a core network.

8. The apparatus according to claim 1, wherein when the first base station is in the first mode, it is configured to broadcast a negative closed subscriber group cell indicator.

9. The apparatus according to claim 1, wherein the at least one processing core is configured to select, based on at least one criterion, one of a plurality of macro base stations to act as the second base station.

10. The apparatus according to claim 1, wherein the apparatus comprises or is comprised in the first base station.

11. A method, comprising:
determining whether to switch a first base station from a first mode to a second mode, wherein when in the second mode the first base station is at least in part controlled by a second base station, and
causing a message comprising an indication of the determination to be transmitted toward at least one of the first base station and the second base station.

12. The method according to claim 11, wherein the first base station being at least in part controlled by the second base station comprises at least one of the first base station allowing the second base station to perform a role of serving base station to user equipments connected to the first base station and the first base station allowing the second base station to manage radio resources of the first base station.

13. The method according to claim 11, wherein the determination is based at least in part on an overload indication received in the first base station from a core network node.

14. The method according to claim 11, wherein the determination is based at least in part on a capability indication received from a user equipment.

15. The method according to claim 14, wherein the capability indication comprises an indication the user equipment supports dual connectivity.

16. The method according to claim 11, wherein when the first base station is in the first mode, a S1 interface connects the first base station to a mobility management entity disposed in a core network.

17. The method according to claim 11, wherein when the first base station is in the first mode, it is configured to broadcast a negative closed subscriber group cell indicator.

18. The method according to claim 11, further comprising selecting, based on at least one criterion, one of a plurality of macro base stations to act as the second base station.

19. An apparatus, comprising:
at least one processor; and
at least one memory including computer program code, wherein
the at least one memory and the computer program code configured to, with the at least one processor, cause the apparatus to perform at least the following:
determine a load condition in a core network node, and
responsive to the determination, cause a message to be transmitted to a base station node, the message comprising at least one of an indication of the load condition and an instruction to switch the base station node from a first mode to a second mode, wherein when in the second mode the base station node is at least in part controlled by a second base station.

20. (canceled)

21. The apparatus according to claim 19, wherein the base station being at least in part controlled by the second base station comprises at least one of the base station allowing the second base station to perform a role of serving base station to user equipments connected to the base station and the base station allowing the second base station to manage radio resources of the base station.

22. (canceled)

23. (canceled)

24. (canceled)

25. (canceled)

26. (canceled)

27. (canceled)
